(19) United States
(12) Patent Application Publication
(10) Pub. No.: US 2008/0202364 A1
(43) Pub. Date: Aug. 28, 2008

(54) Means of attaining large screen print area with new squeegee design

(76) Inventors: Glen Shawn Mallory, Lawrenceville, PA (US); John Stephen Rosettie, Corning, NY (US); Mary Rosettie, Corning, NY (US); Kathleen Ann Wexell, Corning, NY (US)

Correspondence Address: CORNING INCORPORATED, SP-TI-3-1, CORNING, NY, 14831, US

(21) Appl. No.: 11/712,150

(22) Filed: Feb. 28, 2007

(51) Int. Cl. B41F 15/44

(52) U.S. Cl. 101/123

(57) ABSTRACT

An adjustable variable pressure squeegee for screen printing includes a holder having a compliant member coupled to a retainer member and a squeegee blade having an edge coupled to the retainer member.

### FIELD OF THE INVENTION

The invention relates generally to squeegees for screen printing.

### BACKGROUND OF THE INVENTION

Screen printing is a printing process used to create images on a wide variety of substrates, examples of which include glasses, ceramics, metals, and fabrics. Screen printing has three main components: screen, ink, and squeegee. The screen is made of a piece of porous, finely woven fabric stretched over a wood or aluminum frame. A stencil made of impermeable material is formed on or positioned on the screen. The stencil consists of a positive of the image to be printed on a substrate. To print the image on the substrate, the screen is placed on top of the substrate and a paste of ink is applied on the screen. Then, a squeegee is drawn across the screen, whereby the squeegee pushes the ink through open areas of the screen not covered by the stencil onto the substrate. Many factors such as composition, length, angle, pressure, and speed of the squeegee blade determine the quality of the image made by the squeegee.

FIG. 1 shows a standard squeegee 100 including a squeegee blade 102 that is generally rectangular in shape. The squeegee 100 further includes a generally rectangular holder 104 to which an upper edge 106 of the squeegee blade 102 is attached. The lower edge 108 of the squeegee blade 102 is the edge that will make contact with the screen in order to force ink through the screen. An operator or machine grips the holder 104 and applies downward force to the squeegee 100 to enable contact between the squeegee blade 102 and the screen. The design of the holder 104 is such that this downward force is carried only a short distance from its initial focal point. If the squeegee 100 is made long enough to cover a large print area in one continuous stroke, there is the likelihood that there would not be enough pressure along the entire length of the squeegee blade 102 to form a quality screen print. For example, the resulting screen print may have unprinted or blotchy areas.

From the foregoing, there is a desire to provide a squeegee for screen printing that distributes force applied at a point on the squeegee along the entire length of the squeegee.

### SUMMARY OF THE INVENTION

In one aspect, the invention relates to an adjustable variable pressure squeegee for screen printing which comprises a holder comprising a compliant member coupled to a retainer member and a squeegee blade having an edge coupled to the retainer member.

In another aspect, the invention relates to a method of screen printing which comprises placing a screen having a stenciled image thereon on a substrate, depositing ink on the screen, contacting an edge of a squeegee blade coupled to a compliant member with the screen, applying a downward force to the squeegee blade through the compliant member while drawing the squeegee blade across the screen, whereby the ink is pushed through the screen onto the substrate.

Other features and advantages of the invention will be apparent from the following description and the appended claims.

### BRIEF DESCRIPTION OF THE DRAWINGS

The accompanying drawings, described below, illustrate typical embodiments of the invention and are not to be considered limiting of the scope of the invention, for the invention may admit to other equally effective embodiments. The figures are not necessarily to scale, and certain features and certain view of the figures may be shown exaggerated in scale or in schematic in the interest of clarity and conciseness.

FIG. 1 depicts a prior art squeegee for screen printing.

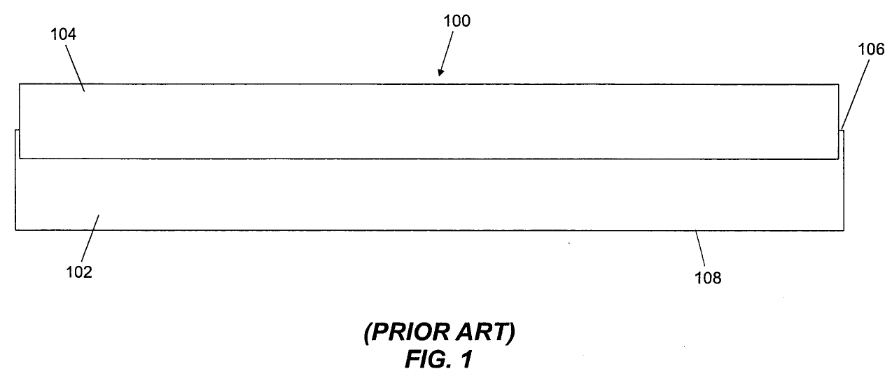

FIG. 2 depicts an adjustable variable pressure squeegee for screen printing.

FIG. 3 is a diagram illustrating a method of screen printing using the squeegee depicted in FIG. 2.

### DETAILED DESCRIPTION OF THE INVENTION

The invention will now be described in detail with reference to a few preferred embodiments, as illustrated in the accompanying drawings. In describing the preferred embodiments, numerous specific details are set forth in order to provide a thorough understanding of the invention. However, it will be apparent to one skilled in the art that the invention may be practiced without some or all of these specific details. In other instances, well-known features and/or process steps have not been described in detail so as not to unnecessarily obscure the invention. In addition, like or identical reference numerals are used to identify common or similar elements.

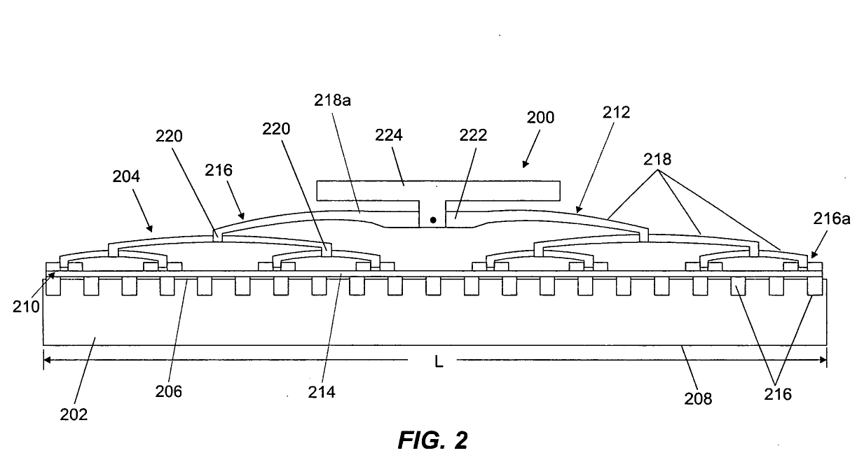

FIG. 2 depicts an adjustable variable pressure squeegee 200 for use in screen printing. The adjustable variable pressure squeegee 200 enables quality screen prints on large areas in one continuous stroke or fewer strokes than possible with standard squeegees. With the adjustable variable pressure squeegee 200, quality screen prints can be achieved with screen print area up to approximately three-quarters of the width of the screen. Historically, the screen print area has been limited to one-third to one-half of the width of the screen in order to achieve quality screen prints. The ability to print quality images on larger areas with screen printing would be useful in many applications, such as in fabrication of solid fuel oxide cell devices. Currently, techniques such as deposition or spray coating surface of substrates are used in printing images on large areas. Screen printing is relatively less expensive than these techniques and can be used to create images on a wide variety of substrates.

The adjustable variable pressure squeegee 200 includes a squeegee blade 202 and a holder 204. The squeegee blade 202 can be any suitable squeegee blade for screen printing. The squeegee blade 202 has a generally rectangular shape. The top edge 206 of the squeegee blade 202 is adapted for retention in the holder 204, while the bottom edge 208 of the squeegee blade 202 is adapted for contact with a screen (not shown) for screen printing and for pushing ink through the screen onto a suitable substrate (not shown). The bottom edge 208 of the squeegee blade 202 may have any desired profile, such as square, round, single-beveled, or double-beveled. The thickness of the squeegee blade 202 can be variable. The length (L) of the squeegee blade 202 can also be variable. The length of the squeegee blade 202 can be selected to achieve quality printing of large areas in one continuous stroke or fewer strokes than possible with standard squeegees. Typically, the length of the squeegee blade 202 will be less than the width of the screen used in screen printing. The squeegee blade 202 is made of a material that is flexible and resistant to the ink used in screen printing. For example, polyurethane or other flexible, high-density plastic may be used in making the squeegee blade 202.

The holder 204 includes a retainer member 210 and a compliant member 212. The retainer member 210 extends along the length (L) of the squeegee blade 202. The retainer 210 includes a base member 214. The bottom portion of the base member 214 includes retaining element(s) for coupling with the top edge 206 of the squeegee blade 202. In this example, the retaining elements are an array of clips 216 which engage the top edge 206 of the squeegee blade 202 on opposites sides. In alternate examples, the retaining element may be a slot or groove or channel in the bottom of the base member 214 for receiving the top edge 206 of the squeegee blade 202. The slot or groove or channel and the top edge 206 of the squeegee blade 202 may be shaped such that they interlock. Alternatively, the retaining element may be a surface depending from the base member 214 and to which the squeegee blade 202 can be attached via screws, clamps, or other suitable attachment devices.

The compliant member 212 generally has a bow-shape. The compliant member 212 includes a pyramid or stack 216 of crossbars or arms 218. In this example, there are three levels of crossbars 218 in the pyramid 216. The pyramid 216 generally includes at least two levels of crossbars 218 and may have more than three levels of crossbars, depending on the length of the base member 214. Typically, a crossbar 218 at an upper level in the pyramid 216 is coupled to two crossbars 218 at a lower level in the pyramid 216. The crossbars 218 are coupled together via flexible connections 220, which allow the compliant member 212 to have a compliant or spring-like response when a downward force is applied to the pyramid 216. Typically, at least a portion of the crossbars 218 in the pyramid 216, for example, those on the sides of the pyramid 216 or the upper portion of the pyramid 216, have a curvilinear shape, which may also be a bow-shape. All the crossbars 218 in the pyramid 216 may also have a curvilinear shape.

In general, the base 216a of the pyramid 216 is approximately as wide as the length of the base member 214. In this example, the crossbars 218 at the base 216a of the pyramid 216 are coupled to the base member 214 and distributed along the length of the base member 214. The manner in which the crossbars 218 are coupled to the base member 214 would depend on the material used in making the crossbars 218 and base member 214. In general, the crossbars 218 at the base 216a of the pyramid 216 are not required to move relative to the base member 214 and can be attached to the base member 214 via any suitable method. As previously mentioned, the crossbars 218 in the pyramid 216 are coupled together by flexible connections 220, which allow the ends of the crossbars 218 to pivot and/or slide where they connect to other crossbars 218. The flexible connections 220 allow the pyramid 216 to act as a spring when a downward force is applied to the pyramid 216, thereby maintaining contact between the squeegee blade 202 and the screen (not shown) across the length of the squeegee blade 202.

Typically, there is only one crossbar 218 at the top of the pyramid 216. In this example, the top crossbar 218 includes a surface 222 for attachment to a handle 224. Downward force can be applied to the pyramid 216 through the handle 224. The handle 224 may be shaped for human use or machine use. In the latter case, for example, the handle 224 may be shaped for coupling to a carriage assembly of a screen printing machine. The handle 224 may be made of any suitable material, such as wood, plastic, or metal, and attached to the top crossbar 218a via any suitable attachment method.

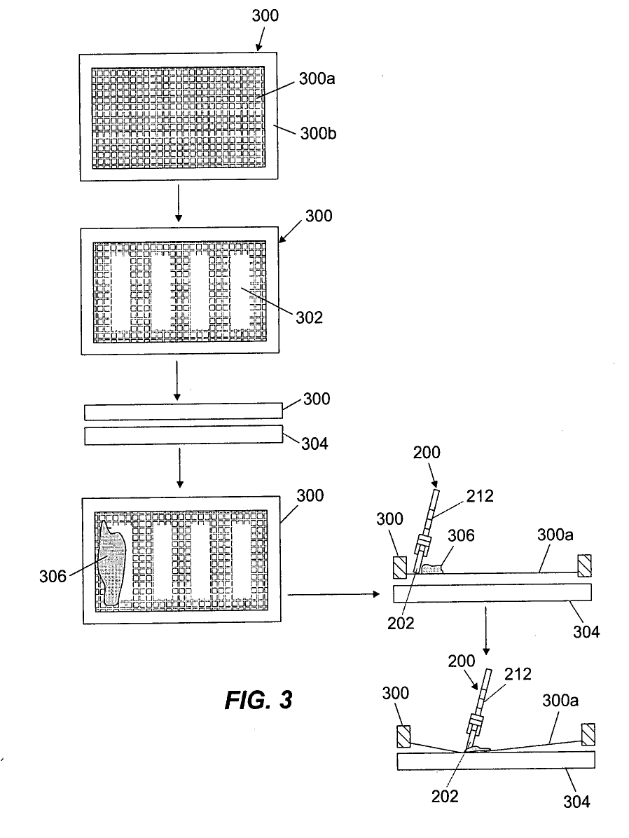

FIG. 3 is a diagram illustrating a method of screen printing using the adjustable variable pressure squeegee 200. The method includes providing a screen assemblye 300 having a screen 300a, typically made of a porous, finely woven fabric, such as nylon, stretched over a frame 300b, typically made of wood or aluminum. The method further includes producing a stencil 302 on the screen 300a. The stencil 302 is a positive of an image to be formed on a substrate. The stencil 302 may be produced on screen 300a manually or by a photochemical process using an impermeable material, that is, a material impermeable to the screen printing ink. The method further includes placing the screen 300 on a substrate 304. The substrate can be any material that can receive ink and which is suitable for the intended application. Examples of substrate materials include glasses, ceramics, metals, and fabrics.

The method further includes depositing ink 306 on the screen 300a. The ink would be selected based on the desired application of the ink-laid substrate. For example, to print a cathode layer of a solid fuel oxide cell device, an ink material suitable for forming a cathode layer would be used. The method further includes positioning the squeegee 200 on the screen 300a. A downward force is applied to the squeegee blade 202 through the compliant member 212 while drawing the squeegee blade 202 across the screen 300a, whereby the ink on the screen 300a is pushed through open areas of the screen onto the substrate 304. The squeegee blade 202 may be drawn at an angle to the screen 300a. While drawing the squeegee blade 202, the compliant member 212 acts as a spring and maintains contact between the squeegee blade 202 and the screen 300a across the entire length of the squeegee blade 202. Also, the downward force applied at the top of the compliant member 212 is distributed along the length of the squeegee blade 202. The method described above can be repeated as necessary to form a multi-layered device.

The adjustable variable pressure squeegee described above enables ink to be laid uniformly on a relatively large print area through a screen. With the adjustable variable pressure squeegee described above, the screen print area can be larger than one-half the width of the screen. With the adjustable variable pressure squeegee described above, the screen print area can be up to three-quarters of the width of the screen. With the adjustable variable pressure squeegee described above, the screen print area can be in a range from one-third of the width of the screen to three-quarters of the width of the screen. With the adjustable variable pressure squeegee, the screen print area can be in a range from one-half of the width of the screen to three-quarters of the width of the screen. Screen printing is a relatively inexpensive method of applying ink to a substrate. With the adjustable variable pressure squeegee described above, large devices, such as solid fuel oxide cell devices, can be fabricated relatively inexpensively using screen printing.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An adjustable variable pressure squeegee for screen printing, comprising:
a holder comprising a compliant member coupled to a retainer member; and
a squeegee blade having an edge coupled to the retainer member.

2. The squeegee of claim 1, wherein the retainer member comprises one or more retaining elements for engaging the edge of the squeegee blade.

3. The squeegee of claim 1, wherein the retainer member and the compliant member extend along a length of the squeegee blade.

4. The squeegee of claim 3, wherein the compliant member is configured such that a downward force applied at a point on the compliant member is distributed along the length of the squeegee blade.

5. The squeegee of claim 3, wherein the compliant member comprises a pyramid of crossbars coupled together.

6. The squeegee of claim 5, wherein at least a portion of the crossbars have a curvilinear shape.

7. The squeegee of claim 5, wherein the crossbars at a base of the pyramid are coupled to and distributed along a length of the retainer member.

8. The squeegee of claim 5, wherein the crossbars are coupled together by flexible connections.

9. The squeegee of claim 5, further comprising a handle member coupled to the holder at a top of the pyramid.

10. The squeegee of claim 1, wherein the compliant member is bow-shaped.

11. A method of screen printing, comprising:
positioning a screen having a stenciled image thereon above a substrate;
depositing ink on the screen;
contacting an edge of a squeegee blade coupled to a compliant member with the screen; and
applying downward force to the squeegee blade through the compliant member while drawing the squeegee blade across the screen, whereby the ink is pushed through the screen onto the substrate.

12. The method of claim 11, wherein the print area of the screen is larger than one-half of a width of the screen.

13. The method of claim 11, wherein the print area of the screen is in a range from one-half of a width of the screen to three-quarters of the width of the screen.

14. The method of claim 11, wherein the substrate is a solid fuel oxide cell substrate.

15. The method of claim 11, wherein the compliant member comprises a pyramid of crossbars.

16. The method of claim 15, wherein the compliant member is bow-shaped.

17. The method of claim 15, wherein the crossbars are coupled together by flexible connections.
